(19) United States
(12) Patent Application Publication
(10) Pub. No.: US 2020/0262707 A1
(43) Pub. Date: Aug. 20, 2020

(54) HYBRID STRUCTURE, SULFUR-HYBRID COMPLEX COMPRISING THE SAME, AND METHOD FOR PRODUCING HYBRID STRUCTURE AND SULFUR-HYBRID COMPLEX

(71) Applicant: KOREA BASIC SCIENCE INSTITUTE, Yuseong-gu (KR)

(72) Inventors: Min Young SONG, Seo-gu (KR); Hae Jin KIM, Yuseong-gu (KR); Jin Bae LEE, Yuseong-gu (KR); Sang Moon LEE, Jung-gu (KR); Won Gi HONG, Yuseong-gu (KR)

(21) Appl. No.: 16/714,323

(22) Filed: Feb. 26, 2020

(30) Foreign Application Priority Data
Dec. 14, 2018 (KR) 10-2018-0162435

(51) Int. Cl. C01B 32/174; H01M 4/58; H01M 10/0525; C01B 33/18

(52) U.S. Cl. CPC C01B 32/174; H01M 4/5815; B82Y 40/00; C01B 33/18; C01P 2004/01; H01M 10/0525

(57) ABSTRACT

The present specification discloses a method for producing a hybrid structure which includes a first step of preparing a mesoporous silica mold; a second step of uniformly mixing and heating a metal chelate compound and the mold to obtain a precursor of the hybrid structure; and a third step of obtaining a hybrid structure by etching the precursor under acid conditions, and wherein the metal chelate compound includes one or more carbon atoms, one or more nitrogen atoms, and one or more metal atoms.

### CROSS-REFERENCE TO RELATED APPLICATIONS

This application claims the benefit under 35 U.S.C. 119(a) of Korean Patent Application No. 10-2018-0162435 filed on Dec. 14, 2018 in the Korean Intellectual Property Office, the entire disclosure of which is incorporated herein by reference for all purposes.

### BACKGROUND

### 1. Field

The present invention relates to a hybrid structure and a method for producing the same, and more particularly, to a sulfur-hybrid complex including the hybrid structure, a method for producing the same, and a cathode for a lithium-sulfur battery including the sulfur-hybrid complex.

### 2. Description of Related Art

A Lithium secondary battery is a battery that essentially contains a cathode, an anode and an electrolyte, characterized in that a lithium cation is reversibly intercalated or deintercalated to the electrode and to be charged and discharged. In the charging and discharging process, electrons and lithium cations that enter the electrode through the current collector serve as to form charge neutrality, and the lithium cations serve as a medium for storing electrical energy in the electrode.

An anode of the lithium secondary battery refers to an electrode from which cations are deintercalated. Since the charge escapes through an external wire together with the deintercalation of the lithium cation, the anode is characterized in that it is oxidized during the discharge process. Typically, an anode of a lithium secondary battery includes lithium metal, carbon material, non-carbon material, and the like, and the carbon material included in the anode is also called as an anode active material.

On the other hand, the lithium-sulfur battery of the secondary battery is a battery that employs a sulfur-based compound including a disulfide bond as a cathode active material. In operation of the lithium-sulfur battery, disulfide bonds dissociate upon discharge, and conversely, disulfide bonds reform upon charge. That is, lithium-sulfur batteries store and generate electrical energy using formation and dissociation of disulfide as a medium. On the other hand, sulfur has a theoretical energy density of 1675 mAhg⁻¹ which is a theoretical energy density of about 4 to 5 times higher than that of a conventional cathode active material.

However, because sulfur having an electrical conductivity of 5×10⁻³⁰ S/cm corresponds to a nonconductor not having an electrical conductivity, even if disulfide bonds are dissociated or generated, there is a problem that the resulting electrons are not easily moved. Therefore, the prior art adopts a method of mixing a conductive material with sulfur in order to complement the electrical conductivity of sulfur. For example, Patent Document 1 proposes a technique for increasing the sulfur content by grinding a sulfur-porous conductive material complex, which is impregnated with a large amount of sulfur, through mechanical milling.

Specifically, Patent Document 1 is characterized in supporting the macroscale porous conductive material in molten sulfur to produce a sulfur-conductive material complex, and pulverizing in a gaseous manner after cooling the sulfur-conductor complex, because the nanostructure porous conductive material is not easy to produce. However, the method described above is likely to damage the precise structure of the conductive material, and as a result, there is a clear limitation that the use of a conductive material including a complex nanostructure is impossible.

That is, there is still a need for a method of improving the battery characteristics of the cathode active material by preserving and utilizing the complex nanostructure of the conductive material, and at the same time, improving the production yield of the nano-sized conductive material and the production yield of the sulfur-conductive material complex.

### SUMMARY

As a result of researching in order to solve the above-mentioned problem, the inventors of the present invention came up with the invention containing the following structures. Specifically, the present specification discloses a producing method of a hybrid structure including: a first step of preparing a mesoporous silica mold; a second step of uniformly mixing and heating a metal chelate compound and the mold to obtain a precursor of a hybrid structure; and a third step of etching the precursor under acid conditions to obtain a hybrid structure, and wherein the metal chelate compound includes one or more carbon atoms, one or more nitrogen atoms and one or more metal atoms.

In the method for producing each hybrid structure of the present invention, preferably, the metal chelate compound is a metal phthalocyanine, and the metal of the metal phthalocyanine is a divalent transition metal ion.

In addition, in the producing method of each hybrid structure of the present invention, it is more preferable that the divalent transition metal ion is a divalent cobalt cation.

In addition, in the method for producing each hybrid structure of the present invention, it is more preferable that the heating of the second step is performed for 4 hours to 6 hours at 600° C. to 1500° C. thermal conditions.

In addition, in the producing method of each hybrid structure of the present invention, it is more preferable that the mold and the metal phthalocyanine are uniformly mixed in the mass ratio of 1:0.8 to 1:2.

On the other hand, the present specification further discloses a hybrid structure including a mesoporous carbon structure; and a carbon nanotube formed from the surface of the mesoporous carbon structure, and wherein the mesoporous carbon structure and the carbon nanotubes each contain one or more nitrogen atoms.

In addition, the present specification further discloses a hybrid structure produced according to the method of producing each hybrid structure of the present invention.

On the other hand, the present specification further discloses a method of producing a sulfur-hybrid complex including: a first step of preparing a mesoporous silica mold; a second step of uniformly mixing a metal chelate compound with the mold and heating to obtain a precursor of a hybrid structure; a third step of obtaining a hybrid structure by etching the precursor under acid conditions; a fourth step of obtaining a sulfur-hybrid complex by mixing the hybrid structure and molten sulfur, and wherein the metal chelate compound includes one or more carbon atoms, one or more nitrogen atoms, and one or more metal atoms.

On the other hand, the present specification further discloses a sulfur-hybrid complex including: a mesoporous carbon structure, and carbon nanotubes formed from the surface of the mesoporous carbon structure, and wherein the mesoporous carbon structure and the carbon nanotube each contain nitrogen atoms, and wherein a sulfur layer is formed on the surface of the mesoporous carbon structure and the surface of the carbon nanotubes.

In addition, the present specification further discloses a cathode active material for a lithium-sulfur battery including a sulfur-hybrid complex, wherein the sulfur-hybrid complex includes a mesoporous carbon structure; a carbon nanotube formed from the surface of the mesoporous carbon structure, and wherein the mesoporous carbon structure and the carbon nanotube each contain one or more nitrogen atoms, and a sulfur layer is formed on the surface of the mesoporous carbon structure and the surface of the carbon nanotube.

In addition, as an extension of it, the present specification discloses a lithium-sulfur secondary battery including a cathode including the cathode active material for lithium-sulfur battery; an anode; and an electrolyte interposed between the cathode and the anode.

### BRIEF DESCRIPTION OF THE DRAWINGS

FIG. 1 is a flowchart summarizing a method for producing a sulfur-hybrid complex of the present invention.

FIG. 2(a) is a scanning electron micrograph of 500 nm magnification, which can confirm a mesoporous carbon complex and a carbon nanotube formed from the surface of the mesoporous carbon complex of a hybrid structure of the present invention.

FIG. 2(b) is a scanning electron micrograph of 1.0 um magnification, which can confirm a mesoporous carbon complex and a carbon nanotube formed from the surface of the mesoporous carbon complex of a hybrid structure of the present invention.

FIG. 2(c) is a scanning electron micrograph of 1.0 um magnification, which can confirm a mesoporous carbon complex and a carbon nanotube formed from the surface of the mesoporous carbon complex of a hybrid structure of the present invention,

FIG. 2(d) is a scanning electron micrograph of 5 nm magnification, which can confirm the bonding relationship between a mesoporous carbon complex and a carbon nanotube formed from the surface of the mesoporous carbon complex of a hybrid structure of the present invention.

FIG. 2(e) is a transmission electron micrograph of 20 nm magnification, which can confirm the bonding relationship between a mesoporous carbon complex and a carbon nanotube formed from the surface of the mesoporous carbon complex of a hybrid structure of the present invention.

FIG. 2(f) is a transmission electron micrograph of 200 nm magnification, which can confirm the bonding relationship between a mesoporous carbon complex and a carbon nanotube formed from the surface of the mesoporous carbon complex of a hybrid structure of the present invention.

FIG. 3 illustrates a nitrogen isotherm curve and pore distribution for the hybrid structure and sulfur-hybrid complex of the present invention.

FIG. 4 is a graph showing the charge and discharge characteristics of the cathode including the sulfur-hybrid complex of the present invention.

### DETAILED DESCRIPTION

The terminology used herein is for the purpose of describing particular examples only. Thus, for example, singular forms include plural forms unless the context clearly requires them to be singular. In addition, the terms “include” or “comprise” as used in the present application are used to clearly indicate that there exists a feature, a step, a function, a component, or a combination thereof described in the specification, and it should be noted that it is not intended to preliminarily exclude the presence of other elements, steps, functions, components, or combinations thereof.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures.

Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure.

The articles “a,” “an,” and “the” are intended to include the plural forms as well, unless the context clearly indicates otherwise.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example or embodiment, e.g., as to what an example or embodiment may include or implement, means that at least one example or embodiment exists where such a feature is included or implemented while all examples and embodiments are not limited thereto.

On the other hand, unless defined otherwise, all terms used herein should be taken to have the same meaning as commonly understood by person of ordinary skill in the art. Accordingly, unless specifically defined herein, a particular term should not be construed in an excessively ideal or formal sense.

The present invention is to solve the above technical problem, to provide a nano-sized hybrid structure having a complex structure.

In particular, it is another object of the present invention to simplify the producing process of the hybrid structure to improve the yield of the producing method.

In addition, another object of the present invention is to provide a sulfur-hybrid complex including the hybrid complex of the present invention and a producing method thereof.

<1. Producing Method of Hybrid Structure>

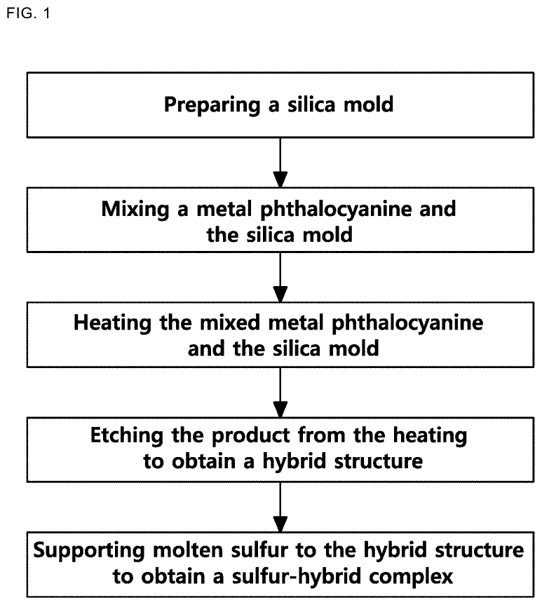

The present specification discloses a method for producing a hybrid structure which includes a first step of preparing a mesoporous silica mold; a second step of uniformly mixing and heating a metal chelate compound and the mold to obtain a precursor of a hybrid structure; and a third step of obtaining a hybrid structure by etching the precursor under acid conditions, and wherein the metal chelate compound includes one or more carbon atoms, one or more nitrogen atoms, and one or more metal atoms. According to the method for producing a hybrid structure of the present invention, a hybrid structure having a complicated structure can be easily obtained through one-pot synthesis. Hereinafter, referring to FIG. 1, the method of producing the hybrid structure of the present invention will be described in detail.

In the method for producing a hybrid structure of the present invention, the first step is to prepare a mesoporous mold. The mold of the present invention is required to be a mold which is less reactive with a metal chelate compound at a high temperature, carbide is not formed by reacting with carbon, and easily removable through etching.

Typically, as for the mold applicable to the present invention, one or more selected from silica, aluminosilicate, alumina, silicon carbide, and styrene-acrylic acid copolymers may be considered. In addition, the use of a silica mold is most preferred in view of the variety and ease of implementation of precise microstructures. Therefore, hereinafter, the first step of the present invention is described on the premise that it is a step of preparing a mesoporous silica mold.

According to the method for producing a hybrid structure of the present invention, the hybrid structure of the present invention is produced using mesoporous silica as a mold. Therefore, the basic structure of the hybrid structure of the present invention is determined by a specific structure of the mesoporous silica. Therefore, in the present specification, the ‘basic structure’ is referred to as ‘mesoporous carbon structure’.

That is, in the hybrid structure of the present invention, the basic structure may be formed by a mold synthesis method using ordered mesoporous silica as a mold. Because mesoporous silica of the present invention is sufficient as long as it can function as a mold, it includes those generally used in the art.

For example, as a silica mold of the present invention, one or more silica molds selected from SBA (Santa Barbara), KIT (Korea Advanced Institute of Science and Technology), MMS (Mesoporous Molecular Sieve), MCM (Mobil Composition of Matter), MSU (Michigan State University), FDU (Fudan University) or TUD (Technische Universiteit Delft) series may be used. A person skilled in the art may select an appropriate silica mold in consideration of the structure and effect to implement, therefore, there is no particular limitation on the type of the mold.

However, the hybrid structure of the present invention may be produced based on the mesoporous silica mold of the KIT series. In this case, from the viewpoint of improving the mechanical properties of the hybrid structure, the basic structure of the hybrid structure of the present invention preferably corresponds to CMK-5, CMK-8, CMK-9 (CMK; Carbon Mesostructured by KAIST). The CMK-5 refers to a two-dimensional tubular carbon skeleton having a SBA-15 or similar hexagonal structure, and CMK-8 (three-dimensional rod) and CMK-9 (three-dimensional tubular) refer to KIT-6 or a three-dimensional carbon skeleton having a similar cubic structure, respectively.

On the other hand, the method for producing a hybrid structure of the present invention includes a second step of obtaining a precursor of the hybrid structure by uniformly mixing and heating a metal chelate compound and the mold. The second step of the present invention is a step performed after the first step is performed, and corresponds to a step of uniformly mixing the silica mold prepared in the first step and the metal chelate compound to obtain a mixture, and heating the mixture to obtain a precursor of the hybrid structure. Meanwhile, in the present specification, the ‘precursor of a hybrid structure’ refers to a material including a silica mold, a mesoporous carbon structure, and a carbon nanotube.

In detail, in the method for producing each hybrid structure of the present invention, the metal chelate compound is preferably metal phthalocyanine, and the metal of metal phthalocyanine is preferably a divalent transition metal ion. More specifically, the metal of the metal phthalocyanine may be any one selected from the group consisting of Fe, Co, Ni, Mn, Cu, Mg, Li, Zn, Ag, Pb, and combinations thereof. The inclusion of the metal enables the formation of nanotubes, which is one feature of the hybrid structure of the present invention.

Moreover, in the producing method of each hybrid structure of the present invention, it is more preferable that a divalent transition metal ion is a divalent cobalt cation.

In addition, in the method for producing each hybrid structure of the present invention, the heating of the second step is, more preferably, carried out for 4 hours to 6 hours at thermal conditions of 600° C. to 1500° C. in terms of forming a regular and repetitive structure of the mesoporous carbon structure.

If the second step of the present invention is carried out under a thermal condition of less than 600° C., the thermal decomposition of the metal chelate compound is not sufficiently performed, and the formation of the mesoporous carbon structure is limitedly performed. On the contrary, if the second step of the present invention is carried out under a thermal condition of more than 1500° C., the specific surface area may be reduced due to collapse of the micropores. In addition, the formation of mesoporous carbon structures having ideal nitrogen content may be limited due to the characteristics of nitrogen which is weak at high temperatures.

In addition, in the method of producing each hybrid structure of the present invention, the heating of the second step may be performed in a reducing atmosphere. Specifically, it is preferable that the heating of the present invention is carried out in a mixed gas atmosphere of H₂ and inert gas (N₂, He, Ar, etc.). By maintaining the reducing atmosphere, it is possible to promote the formation of a product due to thermal decomposition from the metal phthalocyanine and to suppress the formation of the metal complex between the oxidation product and the metal.

On the other hand, the metal chelate compound of the present invention, preferably the metal phthalocyanine is decomposed under the thermal condition, and the resulting decomposition product is adsorbed onto the silica mold so that a mesoporous carbon structure containing nitrogen grows from the surface of the silica mold. Because the metal phthalocyanine is a compound containing both carbon atoms and nitrogen atoms, the decomposition products include not only carbon atoms but also nitrogen atoms.

In particular, according to the method for producing a hybrid structure of the present invention, the synthesis of carbon nanotubes is additionally performed as an extension of the mesoporous carbon structure without stopping from the simple formation of the mesoporous carbon structure. As a result, the synthesis of carbon nanotubes of which the continuity is recognized in terms of mesoporous carbon structure and crystal structure may be confirmed on the surface of the mesoporous carbon structure. Accordingly, the carbon nanotubes of the present invention also contain nitrogen atoms like the mesoporous carbon structures of the present invention.

Moreover, in the producing method of each hybrid structure of the present invention, it is more preferable that a mold and a metal phthalocyanine are mixed uniformly by the mass ratio of 1:0.8 to 1:2. If the ratio of the metal phthalocyanine is less than 0.8, the amount of the precursor to be supported on the silica mold is insufficient to form the structure of mesoporous carbon structure as a whole. On the contrary, when the ratio of the metal phthalocyanine is more than 2, the production of carbon nanotubes is promoted, while the excess precursor aggregates without being supported in the mold. As a result, the structure formation of the intended mesoporous carbon structure may be hindered.

On the other hand, in the method for producing a hybrid structure of the present invention, the third step is a step of obtaining a hybrid structure by etching the precursor of the hybrid structure under acid conditions. The third step of the present invention is a step performed after the above-described first and second steps are performed, and the features of the first and second steps as the preliminary steps of the third step are as described above.

The third step of the present invention is significant as a step of removing the silica mold from the precursor of the hybrid structure. Therefore, the acid condition of the third step is sufficient if an acid compound capable of removing the silica mold is included. As a representative example of the acid compound, hydrofluoric acid capable of forming Si—F bond may be considered, but not particularly limited thereto.

On the other hand, the present specification further discloses a method of producing a sulfur-hybrid complex including: a first step of preparing a mesoporous silica mold; a second step of uniformly mixing and heating a metal chelate compound and the mold to obtain a precursor of the hybrid structure; a third step of obtaining the hybrid structure by etching the precursor under acid conditions of the hybrid structure; a fourth step of obtaining a sulfur-hybrid complex by mixing the hybrid structure and molten sulfur, and wherein the metal chelate compound includes one or more carbon atoms, one or more nitrogen atoms, and one or more metal atoms.

The sulfur-hybrid complex of the present invention has a structure in which a sulfur layer is formed on the surface of the hybrid structure described above. Accordingly, the first to third steps as the preliminary steps of the fourth step of the present invention may be performed in the same manner as the first to third steps described above, and the details thereof are as described above.

The fourth step of the present invention is a step of mixing molten sulfur with the hybrid structure obtained in the third step to obtain a sulfur-hybrid complex. In order to obtain the molten sulfur, it is possible to include the step of heating and melting sulfur as a detailed step of the fourth step.

On the other hand, the step of heating sulfur is preferably carried out at a temperature condition of 120° C. or more. When the temperature condition is less than 120° C., sulfur is not sufficiently melted that the structure of the sulfur-hybrid complex may not be formed properly. When melting is performed at an appropriate temperature condition, the molten sulfur may be formed both on the surface of the carbon nanotubes which is different structure from the surface of the mesoporous carbon structure which is one component of the hybrid complex.

The hybrid structure used in the producing method of the sulfur-hybrid complex of the present invention is characterized by reacting a silica mold and a metal chelate compound in one pot. Thus, the overall process is simple, and even a complex structure of sulfur-hybrid complex can be mass produced at low cost. In particular, the sulfur-hybrid complex, which can be referred to as an end product, can utilize the physical-chemical properties of the carbon structure by including mesoporous carbon structures and carbon nanotubes, and at the same time, it is possible to utilize the physical-chemical properties of sulfur by including a sulfur layer on the surface.

<2. Hybrid Structure>

Hereinafter, the structure of the hybrid structure and the structure of the sulfur-hybrid complex of the present invention will be described in more detail. The present specification further discloses a hybrid structure produced according to the method of producing each hybrid structure of the present invention.

The hybrid structure of the present invention includes a mesoporous carbon structure; and a carbon nanotube formed from the surface of the mesoporous carbon structure, and wherein the mesoporous carbon structure and the carbon nanotube each contain nitrogen atoms. In particular, in the hybrid structure of the present invention, the mesoporous carbon structure and the carbon nanotube constituting the hybrid structure are formed at the same time through a single process from the same precursor. As a result, the carbon nanotube of the present invention is formed on the extension of the mesoporous carbon structure of the present invention, and there is no separate binding unit or a binder.

In addition, when the hybrid structure of the present invention is produced based on the mesoporous silica mold of the KIT series, the mesoporous carbon structures constituting the hybrid structure of the present invention may have the same form as CMK-5, CMK-8 and CMK-9 (CMK; Carbon Mesostructured by KAIST). That is, the outer shape of the mesoporous carbon structure of the present invention may take a hexagonal structure.

On the other hand, in the method for producing each hybrid structure of the present invention, the metal chelate compound is preferably metal phthalocyanine, and the metal of the metal phthalocyanine is preferably a divalent transition metal ion. More specifically, the metal of the metal phthalocyanine may be any one selected from the group consisting of Fe, Co, Ni, Mn, Cu, Mg, Li, Zn, Ag, Pb, and combinations thereof. The inclusion of the metal enables the formation of nanotubes, which is one feature of the hybrid structure of the present invention.

In addition, in the method for producing each hybrid structure of the present invention, the process of heating the mixture of the metal phthalocyanine and the silicon mold is preferably performed in a reducing atmosphere. If the process is carried out in an inert gas atmosphere, there is a risk that the metal ions contained in the metal phthalosainine are further oxidized or converted into metal carbide. On the contrary, if the process is carried out in a reducing gas atmosphere, the metal ions may be converted to a zero-valent iron metal to promote growth of carbon nanotubes.

On the other hand, the diameter of the carbon nanotube included in the hybrid structure of the present invention is between 15 and 25 nm. The carbon nanotube of the present invention shows a clear lattice and high conductivity like graphite.

On the other hand, the present specification further discloses a sulfur-hybrid complex including: a mesoporous carbon structure; and a carbon nanotube formed from the surface of the mesoporous carbon structure, and wherein the mesoporous carbon structure and the carbon nanotube each contain nitrogen atoms, and a sulfur layer is formed on the surface of the mesoporous carbon structure and the surface of the carbon nanotube.

The sulfur-hybrid complex of the present invention may function as a cathode active material by being included in a lithium-sulfur secondary battery. In detail, by including the mesoporous carbon structure and the carbon nanotubes formed from the surface of the mesoporous carbon structure, the sulfur-hybrid complex of the present invention exhibits a characteristic of improved specific surface area and is also expected to implement conductivity as a carbon structure. In addition, because the connection between the mesoporous carbon structure and the carbon nanotubes of the present invention does not require a separate binding unit or a binder, it is characterized in that the electrical and physical disconnection of the mesoporous carbon structure and the nanotubes is not easy when compared with the mesoporous carbon structure and the carbon nanotubes each formed separately.

In addition, the sulfur-hybrid complex of the present invention has a structure in which a sulfur layer is formed on the surfaces of the mesoporous carbon structure and the carbon nanotubes, thereby enabling the implementation of sulfur-specific improved capacity characteristics in addition to the carbon-specific conductivity characteristics. As a result, the sulfur-hybrid complex of the present invention exhibits improved capacity characteristics and rate characteristics as a cathode active material of a lithium-sulfur battery.

On the other hand, the present invention further discloses a cathode including a sulfur-hybrid complex as a cathode active material. A sulfur-hybrid complex included in the cathode of the present invention and the method for producing the same are the same as the description of <1. Method for producing hybrid structure>, <2. Hybrid structure> and the above-mentioned description of <3. Lithium-sulfur battery cathode>.

In detail, in addition to the sulfur-hybrid complex, the cathode of the present invention may further include one or more additives selected from transition metal elements, group IIIA elements, group IVA elements, sulfur compounds of these elements, and alloys of these elements with sulfur. As suitable examples of the transition metal, Sc, Ti, V, Cr, Mn, Fe, Co, Ni, Cu, Zn, Y, Zr, Nb, Mo, Tc, Ru, Rh, Pd, Os, Ir, Pt, Au or Hg and the like can be enumerated. Further, as suitable examples of the group IIIA element, Al, Ga, In, Ti, and the like may be listed. And as suitable examples of the group IVA element Ge, Sn, Pb and the like may be listed.

In addition, the cathode of the present invention may further include a conductive material from the viewpoint of improving the electron conductivity in the cathode. As the conductive material, one having a higher conductivity than sulfur without causing chemical change of the cathode active material containing sulfur is sufficient.

For example, for preferred examples of the conductive material of the present invention, a method of using a single or mixed materials of the following materials may be considered: graphite-based materials such as KS6; carbon blacks such as super-p, denka black, acetylene black, ketjen black, channel black, furnace black, lamp black, summer black, carbon black; carbon derivatives such as carbon nanotubes and fullerenes; conductive fibers such as carbon fibers and metal fibers; metal powders such as carbon fluoride, aluminum and nickel powder; and conductive polymers such as polyaniline, polythiophene, polyacetylene, and polypyrrole.

In addition, from the viewpoint of properly adjusting the capacity characteristics and rate characteristics of the lithium-sulfur battery, the content of the conductive material is preferably added between 0.1 wt % and 20 wt % based on the total weight of the mixture including the cathode active material.

On the other hand, the cathode of the present invention may further include a binder from the viewpoint of improving the adhesive force between the cathode active material of the present invention having a three-dimensional structure and the current collector. As the binder of the present invention, it is required to be a substance having adhesion to both sulfur and the current collector.

For example, as preferred examples of the binder of the present invention, use of poly (vinyl acetate), polyvinyl alcohol, polyethylene oxide, polyvinyl pyrrolidone, alkylated polyethylene oxide, crosslinked polyethylene oxide, polyvinyl ether, poly (methyl methacrylate), polyvinylidene fluoride, copolymers of polyhexafluoropropylene and polyvinylidene fluoride (trade name: Kynar), poly (ethyl acrylate), polytetrafluoroethylene polyvinylchloride, polyacrylonitrile, polyvinylpyridine, polystyrene, derivatives thereof, blends, copolymers and the like may be considered.

The binder may be added of an amount of 2.5 wt % to 30 wt % based on the total weight of the mixture including the cathode active material. When the content of the binder is less than 2.5 wt %, the cathode active material and the conductive material may be dropped, and when the content of the binder exceeds 30 wt %, the ratio of the active material and the conductive material in the cathode may be relatively reduced, and thus battery characteristics may be insufficient from a commercial point of view.

In addition, as for a method of producing the cathode of the present invention, it is possible to use a conventional method. That is, it is possible to produce a cathode by applying a cathode slurry containing a cathode active material of the present invention on a current collector, and annealing it.

Specifically, the cathode slurry includes: a cathode active material of the present invention; a conductive material; a binder; and a dispersion medium. It is preferable that the dispersion medium can dissolve all of the cathode active material; the conductive material; and the binder, but evaporates easily in the annealing process. As examples of the dispersion medium, acetonitrile, methanol, ethanol, tetrahydrofuran (THF), water, isopropyl alcohol and the like may be considered. The density of the cathode slurry of the present invention is not important and may be appropriately selected by a person skilled in the art from the viewpoint of improving the ease of applying.

On the other hand, the current collector may be generally made of a thickness of 3 micrometers to 500 micrometers, and is not particularly limited as long as it has a high conductivity without causing chemical changes in the battery.

Specifically, conductive materials such as stainless steel, aluminum, copper, and titanium may be used, and more specifically, a carbon-coated aluminum current collector may be used. The carbon-coated aluminum substrate has advantages of excellent adhesion to the active material, low contact resistance, and prevention of corrosion of aluminum by polysulfide generated during the oxidation-reduction process of sulfur. The shape of the current collector may vary, such as films, sheets, foils, nets, porous bodies, foams or nonwovens.

In addition, on the extension thereof, the present specification discloses a lithium-sulfur secondary battery including a cathode for a lithium-sulfur battery; an anode; and an electrolyte interposed between the cathode and the anode.

### EXAMPLE AND EVALUATION

Hereinafter, with reference to the accompanying drawings and embodiments, what is claimed in the present specification will be described with more detail. However, the drawings and the examples presented in the present specification may be modified in various ways by those skilled in the art, and may have various forms, and the description of the present specification is not limited to the present disclosure, but it should be seen that all equivalents and substitutes included in the spirit and scope of the present invention are included. In addition, the accompanying drawings are presented to help those skilled in the art to more accurately understand the present invention that it may be shown exaggerated or reduced than the actual.

The silica mold of the present invention was produced through the following producing method. First, 2 g of P123 which is a surfactant was mixed in a solution of HCl 1.5M under ultrasonic conditions, and stirred at 35° C. conditions for 20 hours or more. Second, 0.35 g of ZrOCl was added to the solution, stirred for 2 hours, and then 5 ml of tetraethyl orthosilicate (TEOS) which is a silica precursor was added to the solution and further stirred for about 24 hours. Third, after the aging process for one day at a temperature condition of 95° C., washed repeatedly using filtration, distilled water and ethanol, and then dried for about 12 hours in a 70° C. oven to obtain mesoporous silica (form of powder). Fourth, the dried mesoporous silica was further heat-treated at 600° C. for 5 hours in the air state atmosphere.

### Embodiment 1: Hybrid Structure of the Present Invention

The mesoporous silica and cobalt phtharoselanine were mixed in the mass ratio of 1:1. Thereafter, heating was performed at thermal condition of 900° C. for 5 hours to obtain a precursor of the hybrid structure of the present invention. The heating was carried out under mixed gas (5% H₂/N₂) conditions. Thereafter, the obtained precursor was immersed in a solution in which hydrofluoric acid (HF) and H₂O were mixed in the volume ratio of 1:1, and then etching was performed at room temperature for one day. After etching, the hybrid structure of the present invention was obtained by washing and drying.

### Embodiment 2: Sulfur-Hybrid Complex of the Present Invention

1 g of the hybrid structure of the embodiment 1 and 0.7 g of sulfur powder were mixed and heat-treated at 155° C. for 15 hours to obtain a sulfur-hybrid complex of the present invention.

### Producing Example 1: Cathode Including the Sulfur-Hybrid Complex of the Present Invention

The sulfur-hybrid complex of the Embodiment 2, the conductive material, and the binder were mixed in the mass ratio of 8:1:1 to produce slurry, and then an electrode was produced by coating on a current collector of aluminum foil having a thickness of 20 μm. The conductive material was acetylene black, and the binder was polyethylene oxide (PEO).

### Comparative Example 1: Mesoporous Carbon Structure

Without the use of metal phthalocyanine, phenol and formaldehyde were mixed in the mass ratio of 1:1 and used as a carbon precursor. The carbon polymer was supported on the mesoporous silica using a vapor deposition method which applies heat of 160° C. or more to the carbon precursor. Thereafter, heating was performed at a thermal condition of 900° C. for 5 hours to obtain a precursor of the hybrid structure of the present invention. The heating was carried out under mixed gas (5% H₂/N₂) conditions. Thereafter, the obtained precursor was immersed in a solution in which hydrofluoric acid (HF) and H₂O were mixed in the volume ratio of 1:1, and etching was performed at room temperature for one day. After etching, the mesoporous carbon structure of Comparative Example 1 was obtained after washing and drying.

### Comparative Example 2: Sulfur-Mesoporous Carbon Structure

A sulfur-mesoporous carbon structure was obtained by the same manner as the Embodiment 2, except that the Comparative Example 1 was used instead of the Embodiment 1.

### Comparative Example 3: Cathode Including Sulfur-Mesoporous Carbon Structure Only

A cathode including only the sulfur-mesoporous carbon structure was obtained through the same manner as Producing example 1, except that the sulfur-mesoporous carbon structure of Comparative Example 2 was included in the cathode.

### Evaluation 1: Structural Evaluation of Embodiment and Comparative Example 1

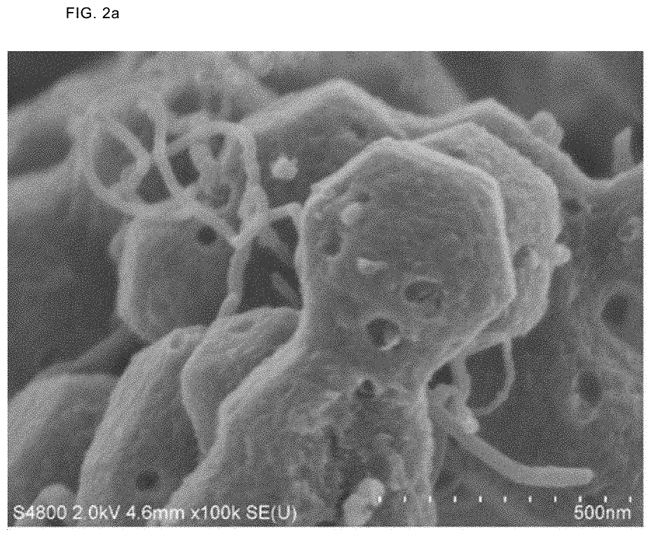

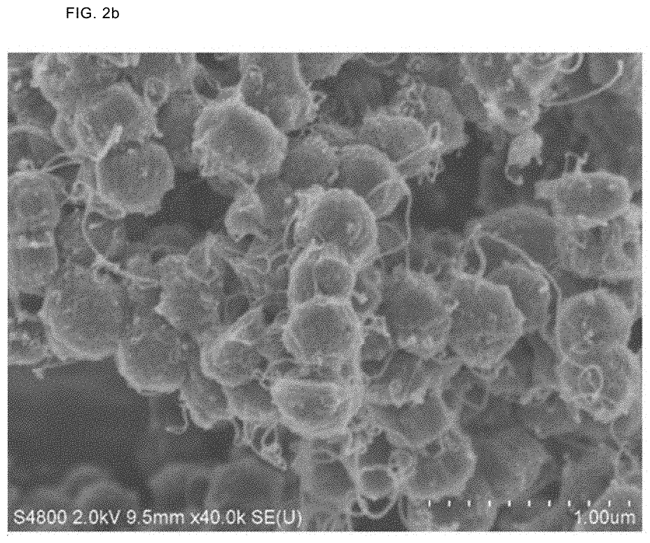

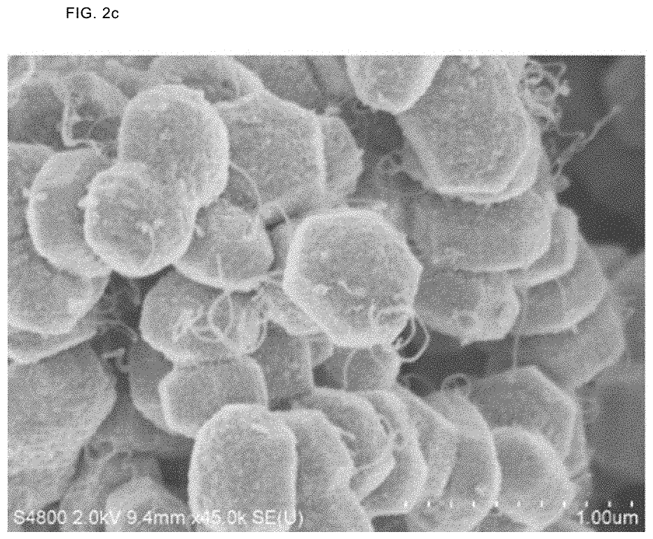

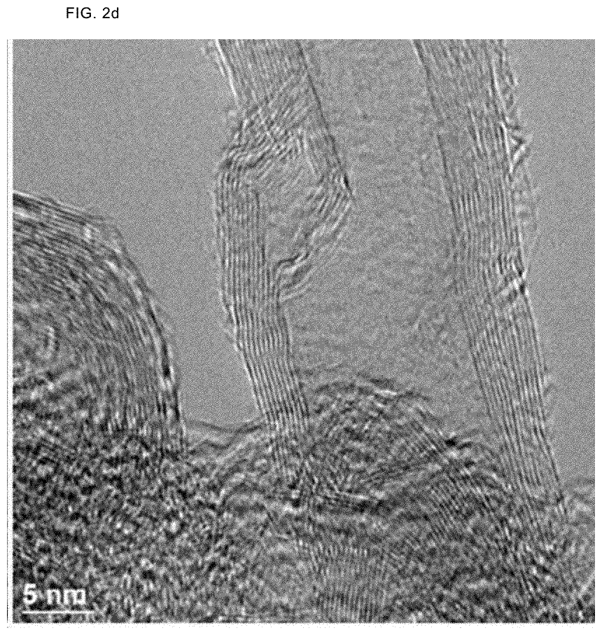

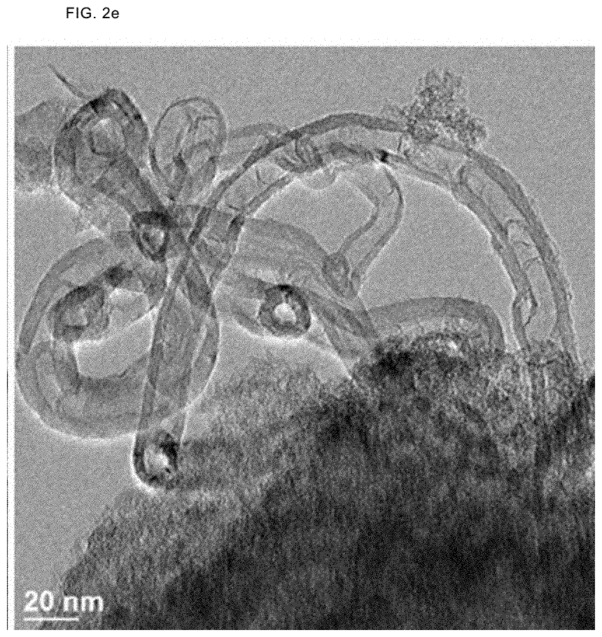

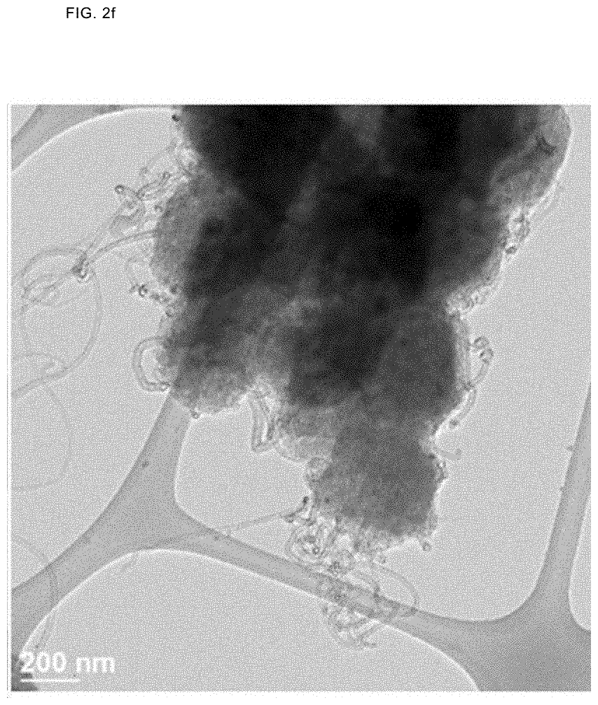

FIG. 2 is an electron micrograph to confirm the structure of the hybrid structure of the present invention. Referring to FIGS. 2 (a), (b) and (c), the external structure of the hybrid structure of the present invention can be confirmed. As described above, the hybrid structure of the present invention includes both the mesoporous carbon complex and the carbon nanotube formed from the surface of the mesoporous carbon complex.

In particular, referring to FIGS. 2 (a), (b) and (c), it can be seen that the carbon nanotube included in the hybrid structure of the present invention is in contact with the mesoporous carbon structure at various points. In the same context, it may be considered that it is possible to improve the conductivity of mesoporous carbon structures through a carbon nanotube.

On the other hand, referring to FIGS. 2 (d), (e), (f), it is possible to more clearly understand the bonding relationship between the mesoporous carbon complex of the present invention and the carbon nanotube formed from the surface of the mesoporous carbon complex.

For example, referring to FIG. 2 (d), it can be seen that the carbon nanotube of the present invention is formed on the extension of the surface of the mesoporous carbon complex. From this, it can be inferred that the method for producing a hybrid structure of the present invention can produce a mesoporous carbon structure and a carbon nanotube from a single raw material in one pot process in one time. In addition, referring to FIG. 2 (e), it can be seen that the carbon nanotubes of the present invention take an accurate tube structure and can be sufficiently extended.

As described later, the hybrid complex of the present invention includes both the mesoporous carbon structure and the carbon nanotube formed from the surface thereof, thereby ensuring improved battery characteristics. In addition, in improving such a battery characteristic, it should be noted that the one-pot formation of a mesoporous carbon structure and a carbon nanotube made from a single raw material is a decisive factor.

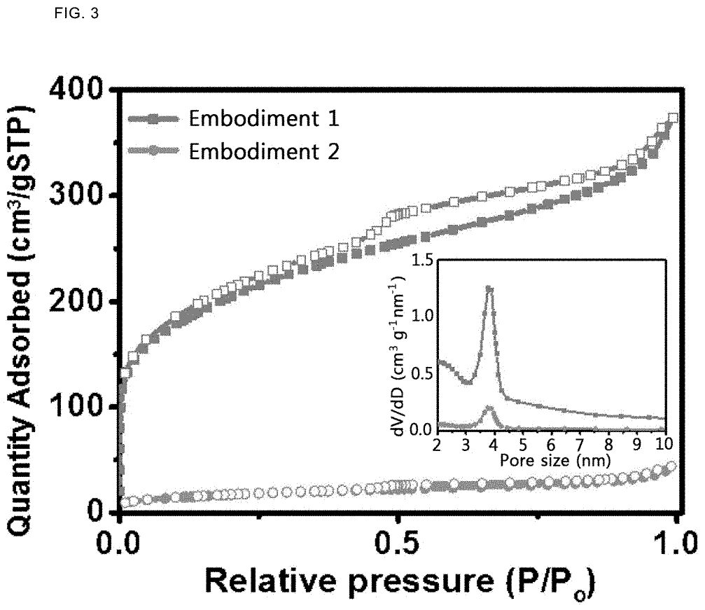

FIG. 3 illustrates a nitrogen isotherm adsorption curve and pore distribution for the hybrid structure and sulfur-hybrid complex of the present invention. The background of FIG. 3 shows a nitrogen isotherm adsorption curve and the inserted view of FIG. 3 shows pore distribution. On the other hand, in each figure, the graph illustrated with square points shows the isothermal adsorption curve and pore distribution diagram of the hybrid structure of Embodiment 1, the graph illustrated with round points is the isothermal adsorption curves and pore distribution of the sulfur-hybrid complex of Embodiment 2.

Referring to FIG. 3, in Embodiment 1, it can be seen that a significant volume of pores were formed on the hybrid structure of the present invention by the mesoporous carbon structure and the carbon nanotube. On the other hand, in Embodiment 2, the molten sulfur layer is sufficiently formed not only on the mesoporous carbon structure but also on the surface of carbon nanotubes, and it can be seen that pores and nitrogen adsorption are reduced.

### Evaluation 2. Evaluation of Capacity Characteristic of the Lithium-Sulfur Battery Including Producing Example 1 or Comparative Example 2

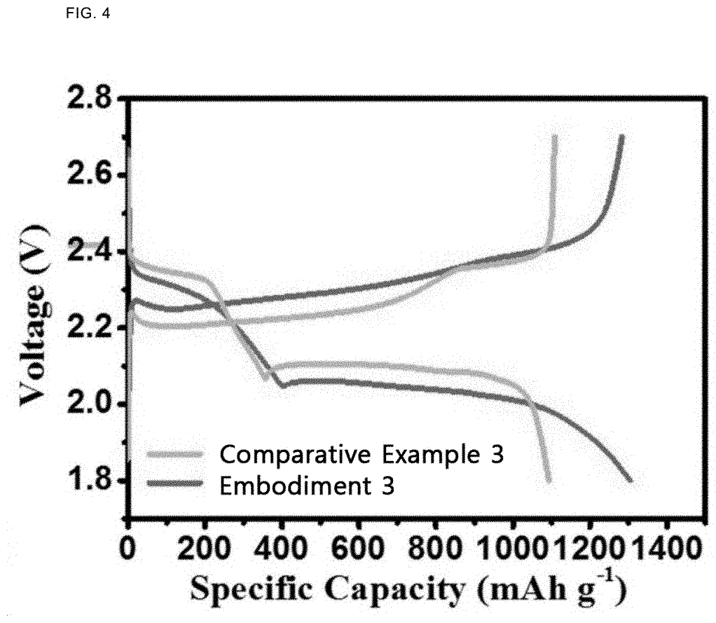

FIG. 4 is a graph showing the charge and discharge characteristics of the cathode including the sulfur-hybrid complex of the present invention. The graph indicated by solid line shows the charge and discharge characteristics of the lithium-sulfur battery including the cathode of Embodiment 3, and the graph indicated with dotted line shows the charge and discharge characteristics of the lithium-sulfur battery including the cathode of Comparative Example 3.

A lithium-sulfur battery coin cell was produced using a 200 μm thick lithium foil as an anode. The coin cell used an electrolyte consisting of TEGDME/DOL (dioxolane)/DME (Dimethylether) (1:1) (1:1:1), LiN (CF₃SO₂)₂ (LiTFSI) 1M, LiNO₃ 0.1M, and the produced coin cell was measured for a capacity from 1.5 to 2.8V using a charge/discharge measuring device. Specifically, charging and discharging efficiency was measured by repeating 50 cycles of charging at 0.2 C rate CC/CV and discharging at 0.2 C rate CC (CC: Constant Current, CV: Constant Voltage).

From FIG. 4, it can be seen that the initial charge and discharge capacity of the lithium-sulfur battery including the cathode of Embodiment 3 is significantly improved by about 20% or more compared with Comparative Example 3. Specifically, the lithium-sulfur battery including the cathode of Comparative Example 3 was initially shown to have a charge and discharge capacity of about 1100 mAhg⁻¹, but the lithium-sulfur battery including the cathode of Embodiment 3 appears to have a charge and discharge capacity of about 1300 mAhg⁻¹.

By employing the above-described means, the present invention can provide a nano-sized hybrid structure including both a mesoporous carbon structure and a carbon nanotube.

In particular, because the method for producing a hybrid structure of the present invention is through a single raw material and one-pot process, it can provide both the implementation of a complex nanostructure containing a large amount of nitrogen atoms and improvement of yield.

In addition, the lithium-sulfur battery using the sulfur-hybrid complex of the present invention as a cathode active material can provide improved charge and discharge characteristics and conductivity.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method for producing a hybrid structure comprising:
a first step of preparing a mesoporous silica mold;
a second step of uniformly mixing and heating a metal chelate compound and the mold to obtain a precursor of a hybrid structure; and
a third step of etching the precursor under acid conditions to obtain a hybrid structure,
wherein the metal chelate compound includes one or more carbon atoms, one or more nitrogen atoms and one or more metal atoms.

2. The method of claim 1,
wherein the metal chelate compound is a metal phthalocyanine, and the metal of the metal phthalocyanine is a divalent transition metal ion.

3. The method of claim 2,
wherein the divalent transition metal ion is a divalent cobalt cation.

4. The method of claim 3,
wherein the heating of the second step is performed for 4 to 6 hours at thermal conditions of 600□ to 1500□.

5. The method of claim 4,
wherein the mold and the metal phthalocyanine are uniformly mixed in the mass ratio of 1:0.8 to 1:2.

6. A hybrid structure comprising:
a mesoporous carbon structure; and
a carbon nanotube formed from the surface of the mesoporous carbon structure,
wherein the mesoporous carbon structure and the carbon nanotube each contain one or more nitrogen atoms.

7. A method for producing a sulfur-hybrid complex comprising:
a first step of preparing a mesoporous silica mold;
a second step of uniformly mixing and heating a metal chelate compound and the mold to obtain a precursor of a hybrid structure;
a third step of etching the precursor under acid conditions to obtain a hybrid structure, and
a fourth step of mixing the hybrid structure and molten sulfur to obtain a sulfur-hybrid complex,
wherein the metal chelate compound includes one or more carbon atoms, one or more nitrogen atoms and one or more metal atoms.

8. A sulfur-hybrid complex comprising:
a mesoporous carbon structure; and
a carbon nanotube formed on the surface of the mesoporous carbon structure, and
wherein the mesoporous carbon structure and the carbon nanotube each contain one or more nitrogen atoms,
wherein a sulfur layer is formed on the surface of the mesoporous carbon structure and the surface of the carbon nanotube.
